(19) United States
(12) Patent Application Publication
(10) Pub. No.: US 2022/0065203 A1
(43) Pub. Date: Mar. 3, 2022

(54) FUEL SUPPLY DEVICE

(71) Applicant: NIKKI CO., LTD., Kanagawa-ken (JP)

(72) Inventor: Yukinori Suematsu, Kanagawa - ken (JP)

(21) Appl. No.: 17/463,532

(22) Filed: Aug. 31, 2021

(30) Foreign Application Priority Data
Sep. 1, 2020 (JP) 2020-147027

(51) Int. Cl. F02M 37/00

(52) U.S. Cl. CPC F02M 37/0052; F02M 37/007

(57) ABSTRACT

A fuel supply device may include a housing including a housing body and a lid. The housing body may form a fuel storage tank. A fuel pump, a regulator, and a fuel storage amount adjusting unit may be disposed in the housing. The lid may have an excess fuel discharge path through which excess fuel flowing down from the regulator is fed to an inner wall side of the housing body. The housing body may have an upward fuel receiving surface that receives the excess fuel discharged at a lower position on an end side of the excess fuel discharge path. The fuel receiving surface may be structured and arranged such that the excess fuel discharged through the excess fuel discharge path is temporarily received by the fuel receiving surface and then returned to the fuel storage tank along an inner wall surface of the housing body.

### BACKGROUND

### Technical Field

The present invention relates to a fuel supply device disposed in the middle of a fuel supply path extending from a fuel tank to an engine, and particularly to a fuel supply device including a fuel storage tank in addition to a fuel pump and a regulator and also serving as a reservoir.

### Related Art

When liquid fuel stored in a fuel tank is supplied to an engine, in order to stably supply the fuel without interruption even when sudden acceleration or sudden deceleration occurs, a fuel supply device that includes a fuel storage tank in addition to a fuel pump and a regulator and functions also as a reservoir is often disposed in the middle of a fuel supply path extending from the fuel tank to the engine.

As described in JP 2008-297941 A, such a fuel supply device includes: a fuel pump that pressure-feeds fuel stored in a fuel storage tank also serving as a reservoir tank inside a housing body toward an engine; a fuel storage amount adjusting unit having a float for maintaining an oil level of the stored fuel at a constant level; and a regulator as a fuel pressure regulating unit. In general, such a fuel supply device adopts a method for returning excess fuel due to pressure regulation from a return port formed below the regulator while flowing down the fuel into the fuel storage tank.

However, when the excess fuel flows down from the regulator to the fuel storage tank as described above, vapor is generated in the stored fuel, or an oil surface thereof is disturbed to swing the float, which hinders stable supply of the fuel to the engine disadvantageously.

In addition, the fuel storage tank also has a function of depositing and removing foreign matters such as moisture and impurities contained in the fuel. However, by flowing down of the excess fuel from the regulator, the foreign matters deposited at a bottom of the fuel storage tank are diffused into the stored fuel and supplied to the engine as they are disadvantageously.

Against such disadvantages, the applicant of the present application has previously proposed in JP 2016-205169 A and JP 2018-105129 A that a regulator holding member 6 as a part for holding a regulator 40 is disposed above a float 50 disposed inside a housing body 20A including a fuel pump 30 and a fuel storage tank 100 as in a fuel supply device 1B illustrated in FIG. 3.

The regulator holding member 6 has a gutter-shaped excess fuel discharge path 62 extending from a recess into which the regulator 40 is inserted and held to an inner wall surface side of the housing body 20A, and has a function of returning the excess fuel to the fuel storage tank 100 along an inner wall surface while feeding the excess fuel to the inner wall surface side of the housing body 20A through the excess fuel discharge path 62.

Therefore, in the fuel supply device 1B, by disposing the regulator holding member 6 as described above on a lower surface side of a lid 20B inside a housing 20, it is possible to prevent generation of vapor in the stored fuel or occurrence of disturbance in an oil surface due to flowing down of the excess fuel from the regulator 40 to the fuel storage tank 100, and it is possible to avoid occurrence of the above-described adverse effects.

However, disposing the regulator holding member 6 having a function of returning the excess fuel to the fuel storage tank 100 along an inner wall surface of the housing body 20A while holding the regulator inside the fuel supply device 1B leads to an increase in the number of parts and an increase in labor in an assembly process, which is likely to be disadvantageous in terms of cost.

### SUMMARY

The present invention is intended to solve the above-described problems, and an object of the present invention is to make it possible for a fuel supply device also servings as a reservoir to stably supply fuel by minimizing occurrence of adverse effects due to flowing down of excess fuel without causing an excessive increase in cost.

A fuel supply device according to an embodiment of the present invention made in order to solve the above problems is disposed in the middle of a fuel supply path extending from a fuel tank to an engine, includes, inside a housing including a housing body forming a fuel storage tank also serving as a reservoir tank and a lid covering and airtightly sealing an opening of the housing body: a fuel pump that pressure-feeds stored fuel; a regulator that returns excess fuel to the fuel storage tank while adjusting the fuel to be pressure-fed so as to have a predetermined pressure; and a fuel storage amount adjusting unit that maintains an oil surface of the fuel stored in the fuel storage tank at a constant level, and feeds fuel at a predetermined pressure from a fuel eject pipe disposed in the lid to supply the fuel to the engine, in which the lid has an excess fuel discharge path through which the excess fuel flowing down from the regulator held inside the lid is fed to an inner wall side of the housing body, the housing body has an upward fuel receiving surface that receives the excess fuel discharged at a lower position on an end side of the excess fuel discharge path, and the excess fuel discharged through the excess fuel discharge path is temporarily received by the fuel receiving surface and then returned to the fuel storage tank along an inner wall surface of the housing body.

As described above, by forming the excess fuel discharge path through which the excess fuel flowing down from the regulator is fed to an inner wall side of the housing body in the lid, and forming the upward fuel receiving surface that receives the fuel discharged at a lower position on an end side of the excess fuel discharge path in the housing body, it is possible to ensure a state in which the excess fuel discharged from the regulator does not directly hit a vertical inner wall surface of the housing body or an oil surface, and to minimize occurrence of adverse effects due to flowing down of the excess fuel without separately disposing a regulator holding member as in a conventional example. Therefore, it is possible to stably supply the fuel without an increase in the number of parts or an increase in labor in assembly.

In addition, in this fuel supply device, if the excess fuel discharge path is formed such that the excess fuel moves by an action of gravity from a lower end side of the return port of the regulator held in the lid to an upper position of the fuel receiving surface formed on the inner wall side of the housing body, it is easy to suppress cost to be low with a relatively simple configuration.

In this case, if the excess fuel discharge path has a longitudinal path extending downward from a lower end side of the return port where an eject port of the excess fuel is formed, the longitudinal path has a discharge port in which a lower end portion is closed by an upward abutting surface and a part of an inner peripheral surface on a lower end side is opened to a side, and the flowing excess fuel is received by the abutting surface and then discharged to an upper position of the fuel receiving surface via the discharge port, it is possible to convert the downward momentum of the flowing excess fuel into a lateral flow toward an inner wall surface side of the housing body while buffering the downward momentum and to discharge the excess fuel onto the fuel receiving surface. Therefore, it is possible to effectively prevent the excess fuel discharged downward from swinging a fuel oil surface or generating vapor with the downward momentum of the excess fuel.

According to the present invention in which the lid has the excess fuel discharge path through which the excess fuel flowing down from the regulator is fed to an inner wall surface side of the housing body, and the housing body has the upward fuel receiving surface that receives the fuel discharged at a lower position on an end side of the excess fuel discharge path, it is possible to stably supply the fuel while minimizing occurrence of adverse effects due to flowing down of the excess fuel without causing an excessive increase in cost.

### BRIEF DESCRIPTION OF DRAWINGS

FIG. 1 is a longitudinal cross-sectional partial view of a fuel supply device according to a preferred embodiment of the present invention;

FIG. 2 is a cross-sectional view taken along line A-A in FIG. 1; and

FIG. 3 is a perspective view illustrating a conventional example.

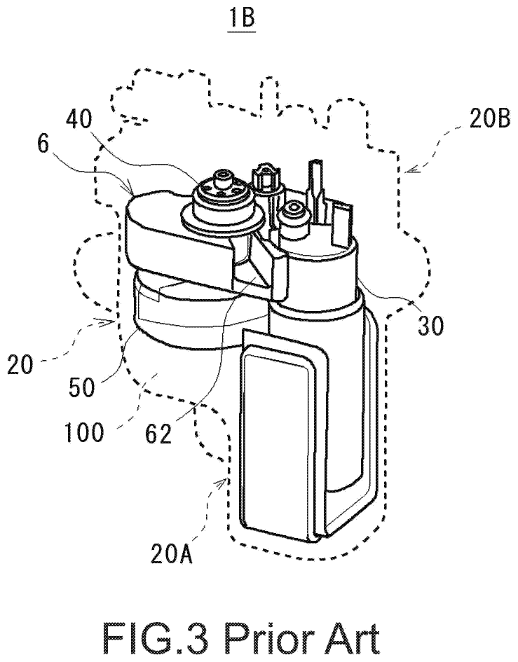

### DETAILED DESCRIPTION

Hereinafter, an embodiment for performing the present invention will be described with reference to the drawings.

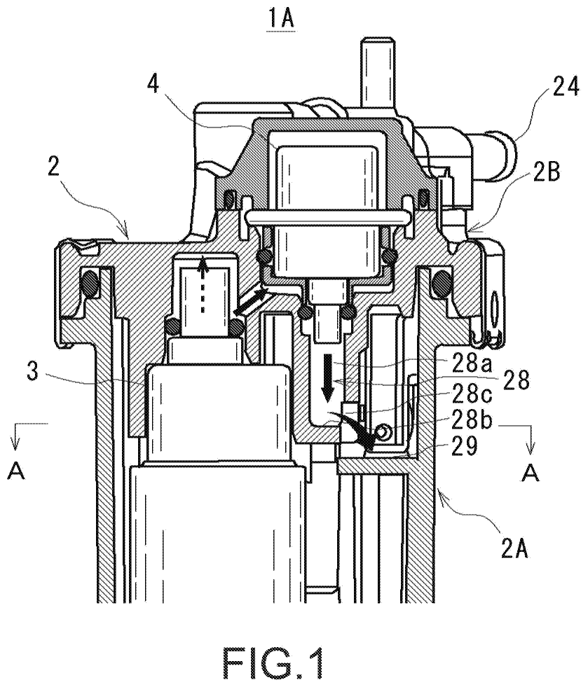

FIG. 1 is a longitudinal cross-sectional view of a fuel supply device 1A of the present embodiment. The fuel supply device 1A includes a fuel pump 3, a regulator 4, and a fuel storage tank (not illustrated) inside a housing 2 that is a housing of the device. The fuel supply device 1A is disposed in the middle of a fuel supply path extending from a fuel tank (not illustrated) to an engine (not illustrated), and thereby functions as a reservoir in addition to functioning as a fuel supply unit. The fuel supply device 1A can stably supply fuel without interruption even when sudden acceleration or sudden deceleration occurs.

The fuel supply device 1A includes a housing body 2A having a fuel storage tank functioning also as a reservoir tank therein, and a lid 2B that airtightly closes an opening of the housing body 2A. The housing body 2A and the lid 2B constitute the hollow housing 2. A fuel introduction pipe (not illustrated) that introduces fuel and a fuel eject pipe 24 that ejects fuel are disposed on an upper surface side of the lid 2B.

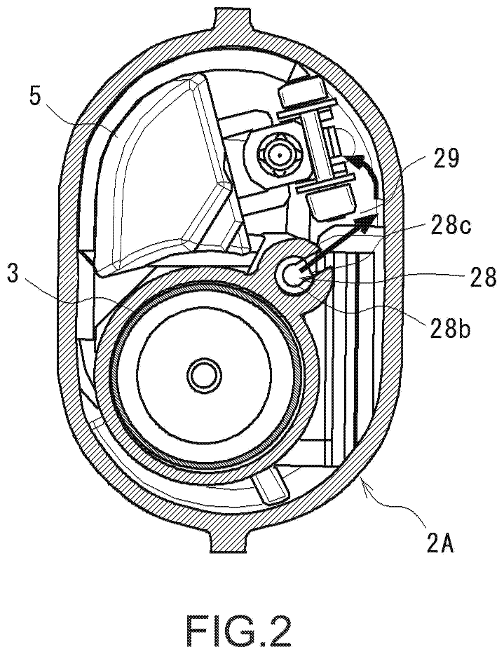

FIG. 2 is a cross-sectional view taken along line A-A in the housing body 2A of FIG. 1, and the housing body 2A includes a fuel storage tank (not illustrated), an electric fuel pump 3 such as a turbine vane pump that pressure-feeds stored fuel, and a fuel storage amount adjusting unit that opens and closes a valve on a proximal end side of a valve lever having a float 5 on a distal end side in a cantilever manner to maintain an oil surface of the stored fuel at a constant level.

In the fuel supply device 1A according to an embodiment of the present invention, the lid 2B holding the regulator 4 while constituting an upper portion of the housing 2 has an excess fuel discharge path 28 through which excess fuel flowing down from the regulator 4 is fed to an inner wall side of the housing body 2A, the housing body 2A has an upward fuel receiving surface 29 that receives the excess fuel discharged at a lower position on an end side of the excess fuel discharge path 28, and the excess fuel discharged through the excess fuel discharge path 28 is temporarily received by the fuel receiving surface 29 and then returned to the fuel storage tank along an inner wall surface of the housing body 2A.

That is, the excess fuel discharge path 28 through which the excess fuel flowing downward from the regulator 4 is fed to an inner wall side of the housing body 2A is integrally disposed in a part of the lid 2B, and the upward fuel receiving surface 29 that receives fuel discharged at a lower position on an end side of the excess fuel discharge path 28 is integrally formed in a state of extending from the inner wall side of the housing body 2A.

Therefore, without adding a regulator holding member to increase the number of parts or to increase labor in an assembly process as in the conventional example, it is possible to minimize occurrence of adverse effects due to flowing down of the excess fuel while ensuring a state in which the excess fuel discharged from the regulator does not directly collide with a vertical wall surface of the fuel storage tank or an oil surface, and it is possible to stably supply the fuel.

In addition, in the present embodiment, the excess fuel discharge path 28 extending from a lower surface side of the lid 2B is formed such that the excess fuel moves as it is by an action of gravity from a lower end side of a return port of the regulator 4 held inside the lid 2B to an upper position of the fuel receiving surface 29 laterally extending from an inner wall surface of the housing body 2A.

Specifically, in the excess fuel discharge path 28, a lower end portion of a longitudinal path 28a extending downward from a lower end side of the return port where an eject port of the regulator 4 is formed is closed by an upward abutting surface 28b, the flowing excess fuel is temporarily received by the abutting surface 28b, and the excess fuel is discharged laterally toward an upper position of the fuel receiving surface 29 through a discharge port 28c formed by opening a part of an inner peripheral surface of the longitudinal path 28a on a lower end side to a side.

Therefore, the excess fuel discharge path 28 converts the downward momentum of the excess fuel ejected from the return port and flowing down through the longitudinal path 28a into a lateral flow by the discharge port 28c opened to a side of the lower end portion of the longitudinal path 28a while buffering the downward momentum by the abutting surface 28b on a lower end side, and discharges the excess fuel toward an upper position of the fuel receiving surface 29 disposed at a position slightly lower than the discharge port 28c. Therefore, it is possible to sufficiently suppress such adverse effects that the excess fuel flowing downward from the regulator 4 swings a fuel oil surface or generates vapor with the downward momentum of the excess fuel.

Note that it goes without saying that the above-described portion constituting the excess fuel discharge path 28 is not limited to the portion disposed integrally with the lid 2B, and may be retrofitted on the lid 2B. In addition, the above-described portion having the fuel receiving surface 29 on an upper surface thereof can be formed not only by integrally molding the portion with the housing body 2A but also by retrofitting a plate-like member or the like on the housing body 2A.

As described above, according to the present invention, the fuel supply device disposed in the middle of the fuel supply path to an engine and also serving as a reservoir can stably supply fuel by minimizing occurrence of adverse effects due to flowing down of excess fuel without causing an excessive increase in cost.

1. A fuel supply device configured to be disposed in a middle of a fuel supply path extending from a fuel tank to an engine, the fuel supply device comprising:
a housing including a housing body forming a fuel storage tank, which also serves as a reservoir tank, and a lid covering and airtightly sealing an opening of the housing body;
a fuel pump that pressure-feeds stored fuel, the fuel pump disposed inside the housing;
a regulator disposed inside the housing, the regulator configured to return excess fuel to the fuel storage tank while adjusting the fuel to be pressure-fed so as to have a predetermined pressure; and
a fuel storage amount adjusting unit disposed inside the housing, the fuel storage amount adjusting unit configured to maintain an oil surface of the fuel stored in the fuel storage tank at a constant level, and feed fuel at a second predetermined pressure from a fuel eject pipe disposed in the lid to supply the fuel to the engine;
wherein the lid has an excess fuel discharge path through which the excess fuel flowing down from the regulator held inside the lid is fed to an inner wall side of the housing body;
wherein the housing body has an upward fuel receiving surface that receives the excess fuel discharged at a lower position on an end side of the excess fuel discharge path; and
wherein the fuel receiving surface is structured and arranged such that the excess fuel discharged through the excess fuel discharge path is temporarily received by the fuel receiving surface and then returned to the fuel storage tank along an inner wall surface of the housing body.

2. The fuel supply device according to claim 1, wherein the excess fuel discharge path is formed such that the excess fuel moves by an action of gravity from a lower end side of a return port of the regulator to an upper position of the fuel receiving surface.

3. The fuel supply device according to claim 2, wherein:
the excess fuel discharge path has a longitudinal path extending downward from the lower end side of the return port where an eject port for the excess fuel is disposed;
a lower end portion of the longitudinal path is closed by an upward abutting surface;
a part of an inner peripheral surface of the longitudinal path on a lower end side is opened to a side forming a discharge port; and
during operation, the excess fuel is received by the abutting surface and then discharged to an upper position of the fuel receiving surface via the discharge port.
